(19) United States
(12) Patent Application Publication
(10) Pub. No.: US 2014/0223707 A1
(43) Pub. Date: Aug. 14, 2014

(54) METHOD AND DEVICE FOR FINISHING WORK PIECES

(71) Applicant: MAG IAS GMBH, Göppingen (DE)

(72) Inventors: Leo Schreiber, Schwäbisch Gmünd (DE); Matthias Weber, Eislingen (DE)

(21) Appl. No.: 14/343,715

(22) PCT Filed: Sep. 18, 2012
(86) PCT No.: PCT/EP2012/068310

§ 371 Date: Mar. 7, 2014

(30) Foreign Application Priority Data
Sep. 18, 2011 (DE) 102011113756.8

(51) Int. Cl. B23P 13/02; B23Q 39/02; B23P 23/04

(52) U.S. Cl. CPC B23P 13/02; B23P 23/04; B23Q 39/02
USPC 29/6.01; 29/888.08

(57) ABSTRACT

In order to shorten a process chain for chip removing processing of a crank shaft after coarse machining and after hardening according to the invention a combination of turn milling or single point milling is proposed as a first step and a subsequent line machining step through finishing or electro chemical etching is proposed.

### I. FIELD OF THE INVENTION

The invention relates to a method and a device for machining rotation symmetrical and also non rotation symmetrical components, in particular crank shafts and mass production, in particular bearing surfaces (of crank pin bearings and also journal bearings) of crank shafts to a useable condition, thus the condition when the crank shaft can be installed in an engine without additional material removal at the bearing surfaces.

Thus bearing surfaces are enveloping surfaces, thus a width of the bearing, and also the so called transom surfaces, thus the faces adjacent to the bearing width which are used for example for axial support.

### II. BACKGROUND OF THE INVENTION

Crank shafts in particular crank shafts for car engines with a high number of cylinders are known to be work pieces that are instable during machining and thus difficult to work on. Determining dimensional compliance of a finished crank shaft is primarily provided besides axial bearing width by assessing the following parameters:
Diameter deviation equals maximum deviation from predetermined nominal diameter of the bearing pinion.
Circularity equals macroscopic deviation from a circular nominal contour of the bearing pin determined by the distance of the outer and inner enveloping circle;
Eccentricity equals radial dimensional deviation for a rotating work piece caused by an eccentricity of the rotating bearing and/or a shape deviation of the bearing from an ideal circular shape;
Roughness represented by mean individual roughness Rz=computational value representing the microscopic roughness of the surface of the bearing;
Support portion=the supporting surface portion of the microscopically viewed surface structure which contacts a contacting opposite surface, and additionally for the crank pin bearings:
Stroke deviation=dimensional deviation of the actual stroke (distance of the actual center of the crank pin from an actual center of the crank journal) from the nominal stroke and
angle deviation=deviation of an actual angular position of the crank pin from its nominal angular position relative to the journal axis and with respect to the angular position of the remaining crank pins designated in degrees or as a longitudinal dimension provided in circumferential direction relative to the stroke.

Thus maintaining required tolerances for these parameters is limited by the available machining methods and also by the instability of the work piece and the machining forces. Also the efficiency and economics of the method are of great importance in practical applications, in particular for volume production where cycle times and thus production costs are of great importance, while singular pieces or prototypes are not subject to these limitations.

Typically material removal from the bearing of the formed thus cast or forged crank shaft was performed in three material removing machining steps:

Step 1. Rough Machining

Chip removing machining through a defined edge. Thus, the methods turning, turn-broaching, turn-turn-broaching, internal circular milling and external circular milling, orthogonal milling, in particular performed as high speed milling or combinations of these methods are used. The excess material to be removed is in a range of several millimeters.

Step 2. Fine Machining:

Wet grinding, in particular after prior hardening of the work piece through a hard, massive grinding tool, for example a grinding disc which typically rotates with its rotation axis parallel to the rotation axis of the crank shaft to be machined; the excess material to be removed is in a range of several 1/10th of a mm.

When there are high excess dimensions the grinding is also performed in plural steps, for example in two steps by pre grinding and finish grinding.

Step 3: Primary Surface Structuring:

Finishing through a typically oscillating grinding tool (grinding band or grinding stone) which is pressed against an outer circumference of the rotating bearing; the excess material removed is typically in the 1/100 mm range or even μm range.

Thus, the processing has to be differentiated based on the material of the crank shaft (steel or cast iron) wherein in particular steel crank shafts which are preferably used for highly loaded components are hardened at the surfaces of the bearings after the first chip removing machining step. This causes renewed warping of the crank shaft which had to be compensated by grinding and finishing. Hardening cast iron crank shafts is currently typically omitted and can be completely avoided by using a cast material with greater hardness like e.g. GGG 60 or 70 and improved strength values.

In order to reduce the cost of crank shaft machining it is desired to reduce the machining of the bearings from three different machining steps to two different machining steps.

Omitting the rough machining step by providing the forming typically forging precise enough so that only fine machining is subsequently required has not been successful so far at least in series production. At least this would have the effect that in particular the material removal to be provided by grinding has to be greater than for the grinding process that has been performed so far.

Disadvantages of removing material through wet grinding however are:
the grinding sludge caused by the added coolant-lubricant is difficult to dispose of;
there is a latent risk of an explosion due to the oil included in the coolant-lubricant e.g. during CBN grinding;
the amount of coolant-lubricant used is much greater for grinding than for chip removing machining methods, since the coolant-lubricant is additionally used for removing grinding dust out of a surface of the grinding disc through high pressure spraying which requires large amounts of energy;
in spite of all the above the risk of overheating the work piece is very high.

Thus it was attempted in the past to minimize the complexity, thus the amount of investment and also machining times and similar for partially hardened work pieces, thus in particular machining after hardening.

Thus it was attempted in particular to eliminate wet grinding and to transition from chip removing machining for example directly to finishing as suggested by DE 197 146 677 A1 while predetermining defined transfer conditions with respect to the individual dimensional parameters.

Also EP 2 338 625 A1 proposes particular fine machining with a defined edge which shall replace the step of wet grinding, however, a finishing is optionally provided thereafter which shall not only improve shape and surface but also dimensional precision to a lesser extent.

Prior optimization attempts, however, do not sufficiently consider the options and in particular the possible combinations of the new machining methods with a defined edge and also with a non defined edge and without edge which meanwhile are also provided in variants for hard machining, thus for machining hardened work piece surfaces and can thus be used at the work piece after hardening.
during turn-milling, thus milling at a rotating work piece fine adjustable (precise down to one μ meter) cutting plates are used in particular for external milling, thus milling with a milling bit that is disc shaped and serrated at its circumference, wherein the cutting plates are arranged for example on wedge systems of the base element of the milling bit, wherein the cutting plates are adjustable precisely enough so that also for 20-50 teeth on a milling bit excellent circularity and diameter precision at the work piece can be achieved.
for an orthogonal milling bit acceptable material removing performance is meanwhile achieved using 1 to 10 cutting edges at the face without influencing surface quality to an excessively negative extent since the cutting edges can not only be adjusted or ground quite well relative to one another but since additionally, and this also applies to an external milling bit the cutting edges are made for example from finest grain hard metal with a very fine grit structure. This helps in particular to partially overcome the previous mutual exclusivity of hardness and elasticity of the cutting edge.
during fine longitudinal turning of the bearing locations there was a problem so far in that turning tools with different elbows were required for turning left and right corner portions and therefore typically a non avoidable step of 10-30μ meters was provided in the transition portion of the two machining locations wherein the step could not be efficiently removed through finishing alone since due to the relatively imprecise self guiding support of the finishing tool a material removal has to be performed for removing the step that is many times greater which requires a large amount of finishing time.

A bearing can be machined with a single turning tool that is feedable in X-direction, moveable in Z-direction and additionally rotatable about a B-axis (single point turning) so that the bearing can be turned without producing a shoulder.
Tangential turning with a cutting edge that is oriented at a slant angle relative to the rotation axis of the work piece and moved along in a tangential or arcuate manner is mean while usable in series production, not only for center bearings but also for rod bearings. When it is not a primary goal for the produced surface to be free from spin grooves a high amount of surface quality is generated with good efficiency.
Dry grinding without a liquid coolant and lubricant can only provide very small material removal, in particular approximately 10-30 μm even when cooling and cleaning of the tool is provided with compressed air.
During finishing sometimes the multi step so called dimensional form finishing is used in which a first step with coarse grit produces a significant material removal of up to 30 μm and may be terminated or continued after measuring.

The second step (finishing of geometry and measuring) and the third step (surface structuring) of finishing with finer grit produces material removal in a range of 5-15 μm and is performed time based and eventually used for surface structuring.

Furthermore there is electrochemical etching of surfaces which shall be used for deburring and special profiling of surfaces, thus in particular for removing the peaks of the microscopic surface structure.

It is well known that it is not only relevant for structuring to remove the peaks but it is also important to keep the valleys open to maintain them as oil reservoirs. In case this is not sufficiently achievable with the known methods like finishing, the known methods can be actively included, for example by including laser beam treatment.

Certainly the precision requirements on the customer side have also increased which are typically at 5 μm regarding circularity, ISO quality level 6 with respect to diameter precision, thus e.g. for a car crank shaft approximately 16 μm and with respect to concentricity between 0.05 and 0.1 mm.

### III. DETAILED DESCRIPTION OF THE INVENTION

### a) TECHNICAL OBJECT

Thus it is an object of the invention to reduce fine machining of the work pieces recited supra to provide usability in particular after hardening, in particular to reduce the number of process steps.

### b) SOLUTION

The object is achieved by the characterizing features of claims 1, 2 and 18. Advantageous embodiments can be derived from the dependent claims.

Thus, it is an object of the present invention to machine the work pieces recited supra and in particular their bearings after chip removing rough machining which achieves a precision of 0.1 mm and possible subsequent hardening which causes additional warping.

The subsequently recited processing steps typically relate to the same machining location.

According to the invention it is presumed that a first finishing step is required after coarse machining, wherein the first finishing step is used for achieving dimensional precision and a second finishing step is used for achieving the respective surface quality.

The first fine machining step is a chipping with a defined edge. This can either be turn milling with an external milling bit which rotates parallel to the work piece during machining or an orthogonal milling bit whose rotation axis is oriented perpendicular or at a slant angle to the rotation axis of the work piece, or the turning, in particular in the form of single point turning which are all capable to machine down to tolerances of approximately 10 μm which, however, shall not always be fully utilized in the process chain according to the invention.

For the second fine machining step in particular material removal with an undefined edge like e.g. fine-dry grinding or finishing, thus in particular the fine steps of dimensional form finishing are available or also electrochemical etching with or without pulsating loading of the electrodes.

Ideally the process chain after coarse machining only includes the first and second fine machining step.

If necessary a fine intermediary step is performed there between (according to claim 2). The following is available:
dry grinding which only provides removing much smaller amounts of material compared to wet grinding for example at the most 150 μm, or
tangential turning thus a machining method with a defined edge, or
the coarse step of dimensional form finishing, or
single point turning is another option in case this was not already selected for the first fine machining step.

It largely depends on customer requirements if a final fine finishing step is required after the second fine finishing step for structuring the surface.

This can be used in particular for introducing cavities as oil reservoirs in the surface of the work piece in order to improve lubrication and thus sliding capabilities.

For this purpose in particular a targeted laser impact can be used for achieving such cavities or in turn electrochemical etching, in case this was not already selected as a machining method for the second fine machining step.

Namely in this case the respective protrusions for relieving the cavities in the work piece are already machined into the electrode for electrochemical etching and the cavities are introduced in one processes step and the peaks of the microscopic surface structure are clipped off.

This way a shortening of the process chain is provided over the conventional process chain and in spite of increased customer requirements. This has the advantage that in particular wet grinding is prevented and additionally depending on the particular combination several process steps can be performed in the same machine and with the same clamping step.

Thus, the machining methods of the first and second fine processing step, besides electrochemical etching, can jointly by implemented in one machine and thus the work piece can be machined in one clamping step.

Even an additional fine intermediary step can be included therein regardless of the actual choice of the machining method for this fine intermediary step.

Even a laser unit for impacting the work piece surface can be additionally used in a machine tool that is basically a turning machine, thus for a work piece that is drive able during processing with a defined and known (C-axis) rotation position.

According to the present invention, however, it is advantageously suggested to perform the second fine machining step directly after the first fine machining step and to use either finishing or electrochemical etching as a second fine machining step.

Thus a material removal of only 10 μm at the most is performed in the second fine machining step. Finishing and also electrochemical etching are performed time based, thus with a defined impact time without measuring the result achieved.

In the first fine machining step, however, the maximum precisions of these methods are not intended, but circularity is machined to a precision of at least 10 μm and diameter is machined to a precision of 10 μm at the most with turn milling. During single point turning, however, a precision of 10 μm at the most is achieved and for the diameter a precision of 10 μm at the most is achieved.

In this first fine processing step, however, the maximum possible precisions of these methods are not approached at all but turn milling provides a precision of at least 10 μm for circularity and a precision of maximum 10 μm for diameter, single point turning however provides circularity with a precision of maximum 10 μm and diameter with a precision of maximum 10 μm.

This is preferably achieved for cutting velocities of 150-400 meters per minute.

In case the material removal and the required precision which still has to be achieved in the second fine machining step are not economically achievable any more the stated fine-intermediary step is performed.

In case electrochemical etching is selected in the fine machining step it is proposed according to the invention to directly arrange protrusions or covers on the effective surface of the electrode used for this purpose, wherein the protrusions or covers then produce cavities in the surface of the work piece in a defined distribution and with a defined depth. These protrusions then have a height of 10 μm at the most; better 6 μm at the most.

However in case a finishing is selected in the second fine machining step, cavities can be produced in a defined manner and in a defined number, size and distribution also through laser impact since also the laser unit can integrated very well in the same machine.

In order to further improve precision in the first fine machining step milling tools are used in which the cutting edges can be subjected to a fine alignment relative to the base element of the tool through wedge systems wherein the fine alignment is more precise than 5 μm in order to achieve machining precisions in a range of 10 μm or below.

Additionally when using an orthogonal cutter, a cutter with 1-10 cutting edges, in particular 4-6 cutting edges at the face is used which however may be distributed unevenly over the circumference in order not to cause any resonance frequency.

Additionally the orthogonal cutter is moved in engagement at the enveloping surface to be processed, typically starting at an outer circumference of the face of the orthogonal cutter in Y-direction relative to the rotation axis of the work piece during the engagement, thus by at least 20% better at least 50% in particular at the most 60% of the diameter of the orthogonal cutter, so that the problem of the cutting performance and cutting direction that is reduced in the center of the orthogonal cutter or which is not present at all due to the lack of cutting edges is solved in that the continuously performed axle offset causes all length portions of the bearing to be machined with sufficient precision.

For this purpose the work piece rotates at least two times while performing the axis offset of the orthogonal cutter, the work piece better rotates at least 10 times or even better at least 20 times.

The speed of the orthogonal cutter should thus be at least 80 times, better 100 times or even better 130 times the speed of the work piece.

When processing hardened surfaces the cutting edges of the chipping tools with defined edge are typically made from CBN or hard metal. The hard metal is then, however, preferably made with a grit of 0.2-0.5 μm and thus rather elastic in spite of having sufficient hardness.

In case electrochemical etching is selected in the second fine processing step, thus a material removal of 30 μm at the most, better only 20 μm is performed, but a removal of at least 2 μm since only this achieves sufficient smoothing of the microscopic surface structure to a support portion of at least 50% which is the general goal for the second fine machining step.

A further acceleration of the production process can be achieved in that the second fine machining step, in particular electrochemical etching only machines the circumferential portion of the lift bearing, thus the rod bearing at the crank shaft which is loaded with the pressure of the connecting rod upon ignition which is always the same circumferential portion.

In particular only the respective half circumference of the rod bearing is processed in the second fine machining step.

This way the first fine machining step can be used for machining the lift bearings thus the rod bearings in the same clamping step and in particular the same clamping step as the proceeding coarse machining which is of interest in particular when hardening is not performed in between or an inductive hardening is also performed in the same machine and in the same clamping step.

In particular in the second fine machining step, though this can also be performed in the first fine machining step, the crank shaft is supported through at least one stationary support.

This generates imprints of the stationary support on the supported bearing circumferences, wherein the imprints are not mandatorily relevant with respect to dimensions and surface quality but shall be finished for optical reasons in that the imprints are removed in a last fine machining step which is facilitated in that the support through the adjacent stationary support is always on the side of the advance direction of the last fine machining step.

In the first fine machining step the flange and the pinion are preferably processed while the crank shaft is supported through a chuck with a centering pin in a center and jaws that pull back respective thereto, wherein the crank shaft is supported on the one hand side by the chuck and at another end by the centering pin.

While the pinion is typically not subjected to a fine machining step it is attempted to produce a spin free surface at the flange in the second fine machining step.

In order to perform the method according to the invention the turning machine employed requires the following:
a machine bed
a spindle stock in particular with a chuck,
an opposite spindle stock with a chuck,
a controlled C-axis,
at least one vertical support,
a milling unit with a disc cutter or with an orthogonal cutter, wherein the orthogonal cutter includes a Y-axis in addition to the X-axis,
optionally a finishing unit and/or a grinding disc rotating about the C-axis.

Advantageously the turning machine also includes the following:
a laser unit for impacting circumferential surfaces of the work piece, and/or an
activatable and de-activatable measuring unit.

### c) EMBODIMENTS

Embodiments of the invention are subsequently described in more detail with reference to drawing figures, wherein:

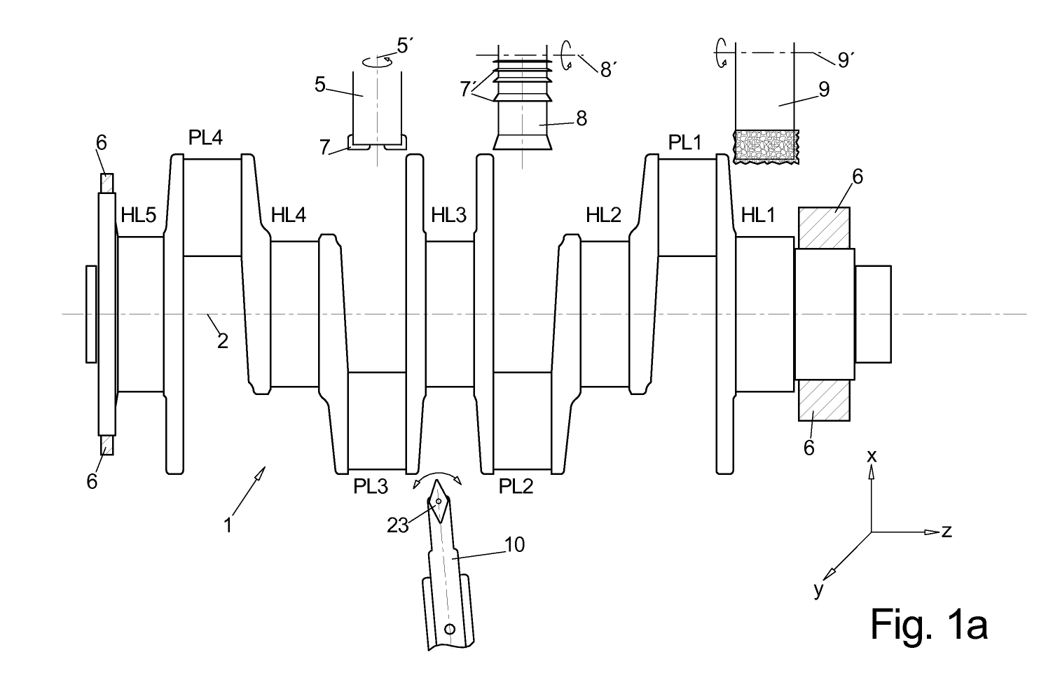

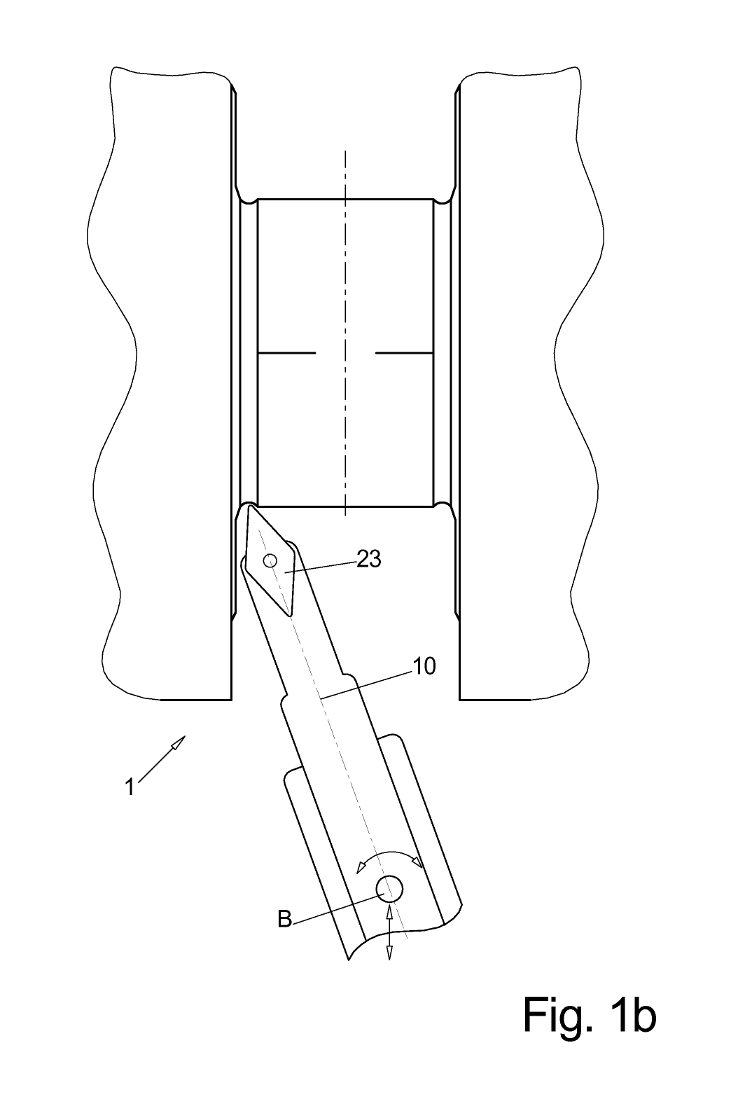

FIG. 1a,b: illustrates a typical crank shaft in a side view and an enlarged individual bearing;

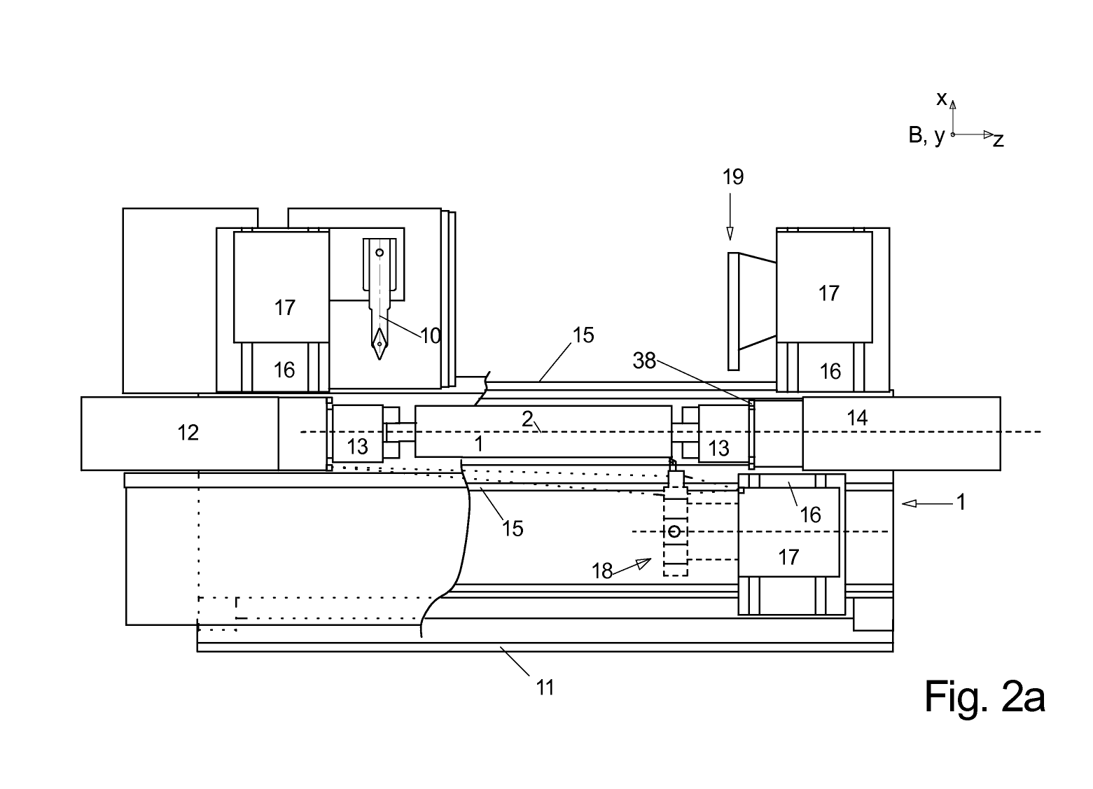

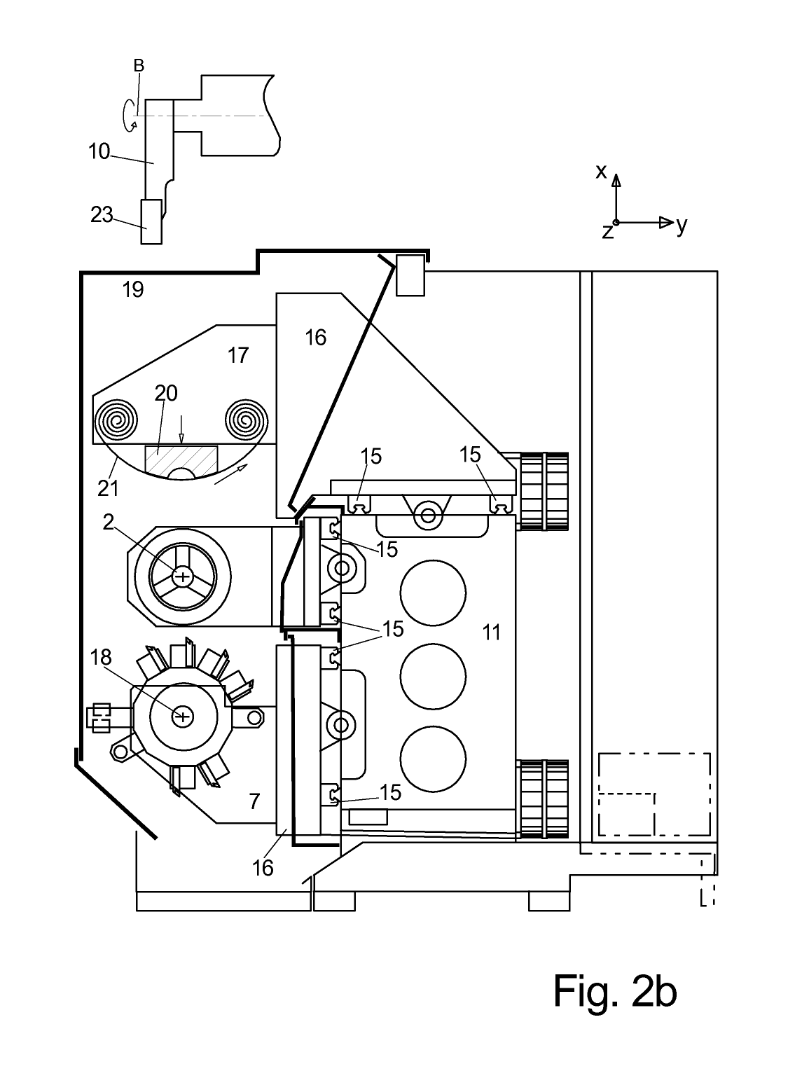

FIG. 2a,b: illustrates a turning machine with supports arranged above and also below the turning axis;

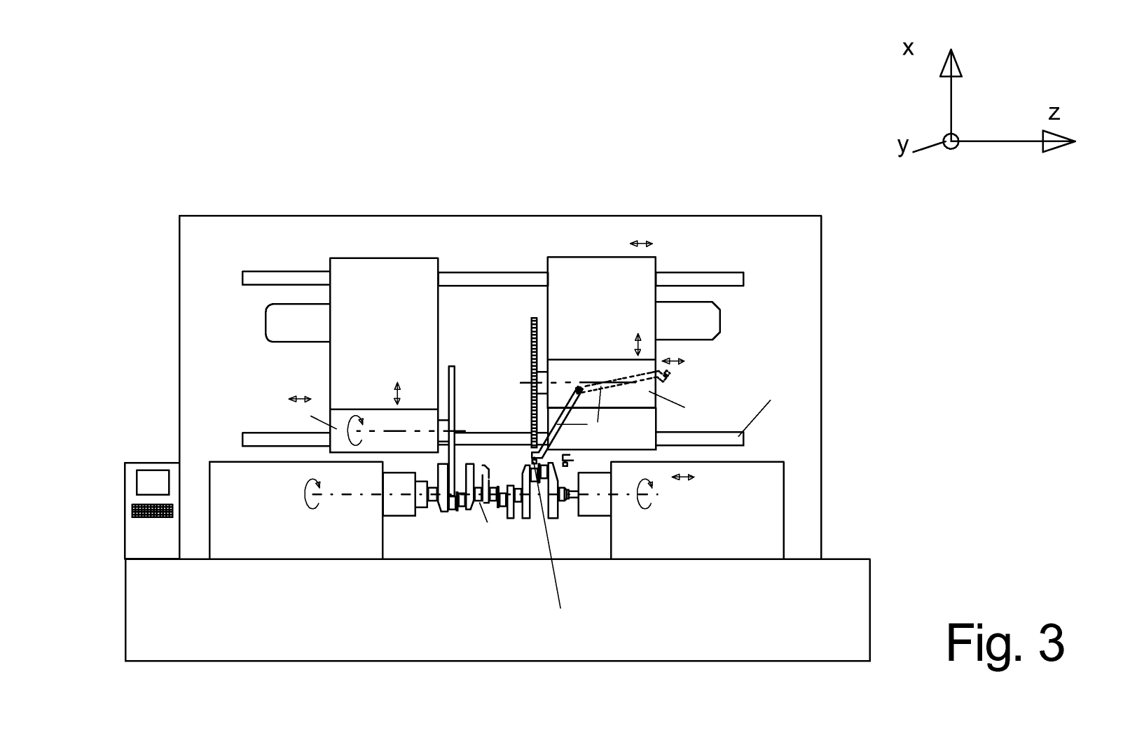

FIG. 3a,b: illustrates a turning machine with supports only arranged above the turning axis;

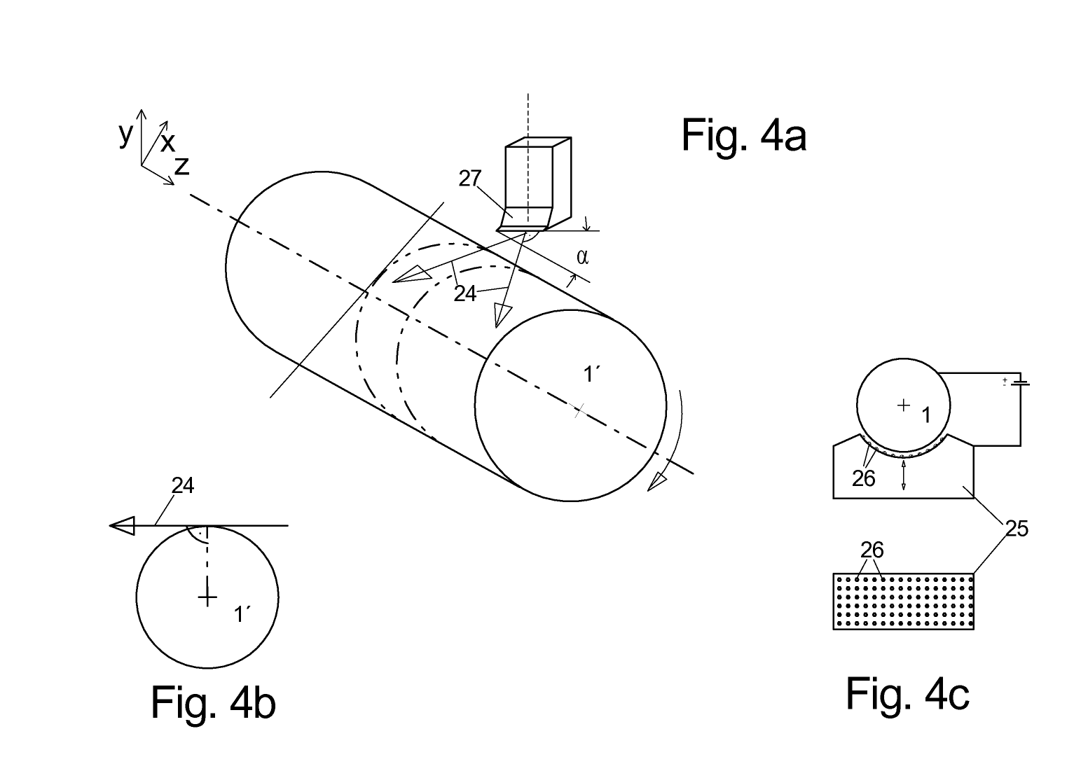

FIG. 4a,b: illustrates different processing situations at a symbolized work piece;

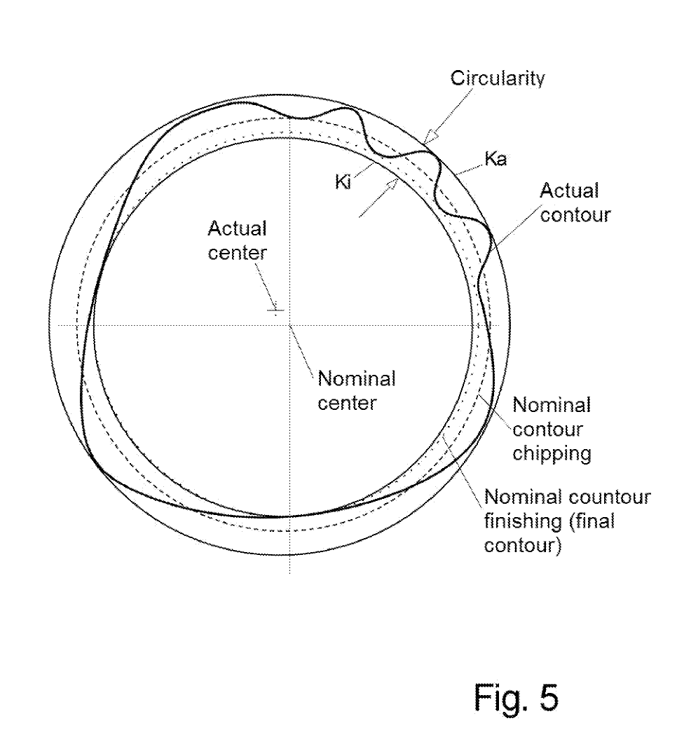

FIG. 5: illustrates dimensional deviations in a cross section of a bearing; and

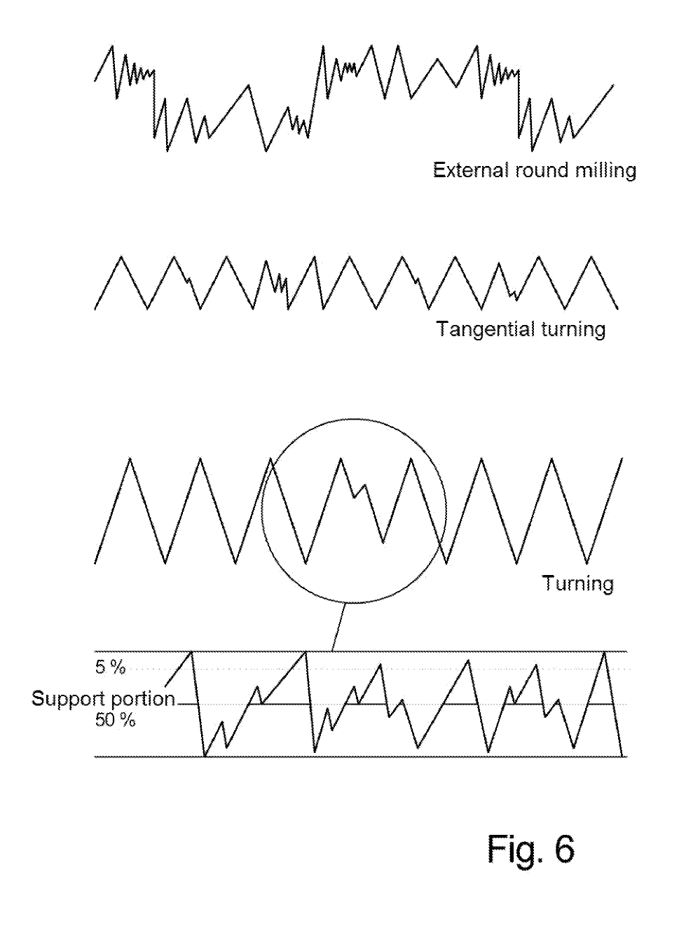

FIG. 6: illustrates microscopic surface structures at a work piece surface.

FIG. 1a illustrates a side view of a typical crank shaft 1 of a four cylinder combustion engine, thus with four eccentrical lift- or rod bearings PL1-PL4 and a total of 5 main bearings HL1-HL5 arranged adjacent thereto, wherein the main bearings are arranged on the subsequent rotation axis (the Z-axis of the crank shaft) on which the crank shaft 1 is clamped in a turning machine that is not illustrated in more detail, wherein the rotation axis is also designated as rotation axis 2 in the illustration of FIG. 1, thus through radial clamping with clamping jaws 6 at the flange 4 at the one end and the pinion 3 at the other end of the crank shaft 1.

The invention relates in particular to machining the enveloping surfaces of the bearings, thus the main bearings and the rod bearings including the adjacent side surfaces, the so called mirror surfaces.

Above and below the crank shaft 1 machining tools are illustrated in an exemplary manner from the top left to the right:
on the one hand side an end mill 5 whose rotation axis 5′ is perpendicular to the rotation axis 2 which is typically defined as Z-axis in a 3 dimensional coordinate system for turning machines;
on the face of the end mill one or plural, preferably 2-8 cutting edges 7 are arranged which extend to the circumferential surface of the end mill 5, so that a bearing can be machined in a chip removing manner through contacting the rotating end mill 5 at an enveloping surface of the rotating bearing.
adjacent thereto a disc cutter 8 is arranged whose rotation axis 8′ is parallel to the Z axis and on whose circumference a large number of cutting edges 7′ is arranged which extend along the entire width of the circumferential surface and radially over the outer edge portion of the disc shaped base element of the disc cutter 8.

Due to the large number of typically 80 cutting edges or cutting plates 23 which have to be adjusted at a disc cutter 8 with for example 700 mm diameter the exact adjustment in radial and in axial direction in sync with all cutting plates is very time consuming.
on the right side adjacent thereto a grinding disc 9 is illustrated that rotates about a rotation axis 9′ that is arranged in Z-direction which is covered in her enveloping portion and in the adjacent face portions with abrasive grit, typically hard metal, ceramics or CBN and typically has an axial extension that is measured in Z-direction like the disc cutter 8, wherein the axial extension corresponds to the respective bearing.

Below the crank shaft a turning tool 10 configured as a single point turning tool is illustrated, wherein the turning tool does not extend exactly in X-direction but at a slight slant angle thereto in a direction towards the bearing and can contact the bearing in order to be able to also turn one of the corners of the bearing.

In order to turn both corners including the enveloping surfaces without stopping and thus without a shoulder with the same turning tool 10, this turning tool 10 as illustrated in FIG. 1b in a detail view is pivotable about the B-axis in addition to a moveability in X-direction and certainly sufficiently slender in order to move in the bearing.

It is appreciated that machining one of the rod bearings PL1-PL4 at the crank shaft rotating about the main bearing axis, the engaging tools additionally have to perform a feed movement in X-direction and for the end mill 7 and for the cutting tool 10 an additional feed movement in Y-direction is required in order to be able to follow the orbiting rod bearing.

FIG. 2a and b illustrate an embodiment of a turning machine in a frontal view in Z-direction which can be used for machining work pieces like crank shafts with the methods according to the invention.

As illustrated in FIG. 2b a spindle stock 12 is arranged in front of the vertical front face of the machine bed 11 in its upper portion, wherein the spindle stock 12 supports a clamping chuck 13 that is drive able to rotate and includes clamping jaws 6. An opposite spindle stock 14 is arranged opposite to the spindle stock 12 wherein the opposite spindle stock 14 also supports a clamping chuck 13 so that a work piece, for example a crank shaft 1, can be received with both its ends on the rotation axis 2, which extends in Z-direction, in one respective clamping chuck 13 and can be driven in rotation.

On the front side of the bed 11 below the rotation axis and on the flat top side of the bed 11 longitudinal guides 15 are arranged respectively extending in pairs in Z-direction, wherein tool units are moveable on the longitudinal guides, in this case one tool unit on the lower longitudinal guides and two tool units on the upper longitudinal guides 15.

Each tool unit is made from a Z-slide 16 that is moveable along the longitudinal guides 15 and an X-slide 17 extending on the Z-slide and moveable in X-direction, wherein the tool or the tool unit are mounted on the X-slide.

In the unit below the rotation axis 2 this is a typical tool revolver 18 with a turning tool 10 inserted therein configured as a star revolver and with a pivot axis that extends in Z-direction.

The left upper unit is an individual turning tool 10 in single point configuration, thus pivotable about the B-axis which extends approximately in X-direction and thus moveable in X-direction also in accordance with the pivot movement.

The right upper unit is a finishing tool 19 which can make a circumferential surface at the work piece smoother.

In FIG. 2b this finishing tool 19 is illustrated viewed in Z-direction. Therein it is evident that this tool includes a finish form piece 20 with a cavity according to the convex circumferential surface of the work piece to which it shall be attached, e.g. configured as a semi circle and a finish band 21 which is run over the contact surface of the form piece 20 and is wound on a respective storage roll with its ends.

Also a single point turning tool 10 is illustrated again in this view adjacent there to in FIG. 2b.

FIG. 3 on the other hand side illustrates a turning-milling machine in which in turn a crank shaft 1 is supported again as a work piece by spindle stock and opposite spindle stock 14 between two clamping chucks oriented against one another drive able in rotation about the rotation axis 2 which is configured as a C-axis, like in the turning machine of FIGS. 2.

In this case longitudinal guides 15 are only arranged at the machine bed 11 above the turning axis 2, wherein two tool units with Z-slides 16 and X-slides 17 running thereon are provided.

In this case the right X-slide 17 supports a disc cutter 8 which rotates parallel to the rotation axis as indicated in FIG. 1 and the left Z-slide 17 supports a grinding disc 9 which also rotates about an axis parallel to the Z-axis.

Additionally a measuring unit 22 is provided at the right X-slide 17, wherein the measuring unit can be activated and deactivate by pivoting in order to perform measurements at a circumferential surface with respect to diameter, circularity, longitudinal position of the transom surface without unclamping or re clamping the work piece in that a measuring probe to be approached in X-direction contacts the circumferential surface.

FIG. 4a illustrates processing a portion of a circumferential surface not with reference to a crank shaft but with reference to a circumferential work piece which could be the circumferential surface of the lift bearing or rod bearing, through tangential turning.

Thus, a straight or concave cutting edge that is arranged skewed to the rotation axis of the rotating work piece is moved in a tangential moving direction 24 contacting at the circumferential surface of the work piece, for a straight edge in a tangential in a straight direction and for a convex edge in a tangential, arcuate direction about a pivot axis which extends parallel to the rotation axis 2.

Thus, only very small excess dimensions can be removed; however the machining result is very precise and has an excellent surface.

In FIG. 4c electrochemical etching is illustrated.

Thus, an EMC electrode 25 whose contact surface is advantageously adapted to the contour of the circumference of the work piece produced and which includes a respective cavity is moved towards the work piece, wherein an electric current or an electric voltage is applied between the work piece on the on hand side and the electrode 25 on the other hand side and additionally a salt solution or acid is introduced between both of them.

When these parameters are selected accordingly, portions proximal to the surface, in particular the peaks of the microscopic surface structure of the work piece are etched off and carried away in the salt solution. For improvement purposes the electrode 25 can be moved in a pulsating manner radially and axially in order to optimize extraction through salt solution or acid.

As a matter of principle the work piece can be rotated about the rotation axis 2.

However, when a plurality of small microscopic protrusions 26 is provided on the contact surface of the electrode surface 25 like in the illustrated case which are used for producing respective microscopic cavities in the surface of the work piece which are subsequently used as oil reservoirs, the work piece certainly has to be machined while standing still.

Otherwise such microscopically fine cavities, typically only with a depth of a few μm, can also be produced through laser impact.

Thus FIG. 6 has different microscopic surface structures which are typical for different chip removing machining methods with a defined edge.

Longitudinal turning yields a typically uniform saw tooth profile whose roughness Rz is in the range of 3-10 μm.

The surface structure after tangential turning leads to a less uniform structure than the periodicity of longitudinal turning and with a much smaller distance between peaks and valleys with an Rz of approximately 1.5-5 μm.

For external circular milling, however, it is typical that the surface structure includes portions thereafter which are microscopically on different levels according to the impact of the individual milling blades after one another on the work piece and the very fine facets on the work piece thus formed.

The lower portion FIG. 6 illustrates an enlarged microscopic structure and the desired 50% support portion after removing the peaks which is approximately desired for bearings.

Thus it also becomes clear that additional removal of the peaks and increasing support portion, in particular during finishing, the surface to be machined by the tool becomes larger and larger and thus the removal in radial direction becomes slower and slower.

FIG. 5 illustrates—viewed in the direction of the Z axis—a sectional view through a bearing e.g. of a crank shaft whose nominal contour is an exactly circular contour. In practical applications, however, this is a non circular contour that is generated at least after the chip removing machining with a defined cutting edge through an influence of particular interfering parameters.

Thus in order to determine circularity an inner enveloping circle Ki and an outer enveloping circle Ka is applied to the actual contour and the distance of the two enveloping circles defines circularity.

Additionally also the actual center of the respective bearing may not exactly coincide with the nominal center which is the case in particular for lift bearing pins and has a negative influence on concentricity.

Furthermore, the nominal contour after finishing is defined, thus the final contour which is accordingly radially within the nominal contour after chipping with the defined edge is completed.

### REFERENCE NUMERALS AND DESIGNATIONS

1 crank shaft

1′ work piece

2 rotation axis

3 pinion

4 flange

5 end mill

5′ rotation axis

6 clamping jaw

7, 7′ cutting edge

8 disc cutter

8′ rotation axis

9 grinding disc

9′ rotation axis

10 turning tool

11 machine bed

12 spindle stock

13 clamping chuck

14 opposite spindle stock

15 longitudinal guide

16 Z- slide

17 X-slide

18 tool revolver

19 finishing tool

20 finishing form piece

21 finishing band

22 measuring unit

22a measuring probe

23 cutting plate

24 tangential movement direction

25 ECM electrode

26 protrusion

27 tangential turning tool

1. A method for finishing work pieces ready to use with rotation symmetrical and optionally non rotation symmetrical circumferential surfaces, wherein the circumferential surfaces are arranged concentric and also eccentric, and adjacent side surfaces, having crank shafts,
wherein after a chip removing rough machining and subsequent partial hardening of the circumferential surfaces fine machining of the circumferential surfaces is performed, said method comprising the following steps:
performing a first fine machining step with a defined cutting edge, through
turn milling in the form of external milling or orthogonal milling or,
turning in the form of single point turning;
immediately followed by
performing a second fine machining step through
fine stage finishing of dimensional form finishing or
electrochemical etching (ECM) with pulsating loading of the electrode (PECM).

2. A method for finishing work pieces ready to use with rotation symmetrical and optionally non rotation symmetrical circumferential surfaces which are concentric and also eccentric and adjacent side surfaces, having crank shafts wherein fine machining of the circumferential surfaces is performed in the following steps after a chip removing coarse machining and subsequent partial hardening of the circumferential surfaces which method comprises:
performing a first fine machining step with a defined cutting edge, through
turn milling in the form of external milling or orthogonal milling or,
turning, in the form of single point turning;
performing a fine intermediary step through,
dry grinding,
tangential turning
coarse step of dimensional form finishing, or
single point turning;
performing a second fine machining step through
fine dry grinding,
finishing, with a fine step of dimensional form finishing, or
electrochemical etching (ECM), with pulsating loading of the electrode (PCM); and
performing,a fine completion step for structuring the surface of cavities through,
laser impact or,
electrochemical etching (ECM).

3. The method according to claim 1, characterized in that a fine completion step through laser impact is performed after the second fine machining step in case the second fine machining step was finishing, the fine stage of dimensional form finishing.

4. The method according to claim 1 characterized in that the first fine machining step includes
machining main hearings (HL) through single point turning, and
machining lift bearings or rod hearings (PL) through turn milling in the form of circumferential milling and
turn milling uses cutting speeds of 250-400 m/min and/or machining is performed for circularity down to a precision of 15 μm and for diameter down to a precision of 20 μm or more precisely when finishing or ECM follows.
single point turning uses cutting speeds of 250-400 m/min, and/or machining, is performed for circularity at least down to a precision of 10 μm and for diameter down to a precision of 10 μm.

5. The method according to claim 1 characterized in that in case the second fine machining step was electrochemical etching (ECM), the electrode includes protrusions in a defined distribution over its effective surface wherein the protrusions have a height of 10 μm at the most, for introducing cavities into the work piece surface.

6. The method according to claim 1 characterized in that multi stage finishing includes laser impact before the last finishing step.

7. The method according to claim 1 characterized in that orthogonal milling uses a cutter with 2-8 cutting edges, which may be especially unevenly distributed over a circumference.

8. The method according to claim 1 characterized in that milling uses tools with cutting edges which facilitate a fine alignment relative to a base element of the tool through wedge systems.

9. The method according to claim 1 characterized in that orthogonal milling includes advancing the engaging cutter in Y-direction by at least 40% of its diameter, wherein the work piece performs at least 5 revolutions during that time period.

10. The method according to claim 1 characterized in that orthogonal milling is performed at a speed of the orthogonal cutter that is at least 80 times the speed of the work piece.

11. The method according to claim 1 characterized in that during external milling the diameter of the cutter is at least 40 times of a stroke of a crank shaft to be machined and/or cutting edges are made from finest grain hard metal.

12. The method according to claim 1 characterized in that electrochemical etching (ECM) includes a material removal of 30 μm at the most, but at least 5 μm.

13. The method according to claim 1 characterized in that electro chemical etching (ECM) only treats the respective half circumference of the surface portion of the rod bearing which is subjected to rod pressure during ignition.

14. The method according to claim 1 characterized in that in a first fine machining step lift bearings and rod bearings are machined in the same clamping step and in the same clamping step as the preceding coarse machining and thus the crank shaft is supported at the flange and pinion with clamping chucks.

15. The method according to claim 1 characterized in that in a second fine machining step the crank shaft is respectively supported with a vertical support at a bearing that is already fine machined in a second step, wherein the vertical supporting is performed at a main bearing that is directly adjacent to the bearing to be machined, and in a last fine machining step the vertical support impressions that are produced on the machined bearings are removed, wherein the support is always provided on a side in the advance direction in this last step.

16. The method according to claim 1 characterized in that a first fine machining step machines flange and pinion, wherein the crank shaft is radially supported at a main bearing adjacent to the machining location, supported with a vertical support.

17. The method according to claim 2 characterized in that the first fine machining step is performed with a defined edge and the finishing and/or laser impact and/or dry grinding and/or tangential turning and/or single point turning are performed in the same machine and in the same clamping step of the work piece.

18. A turning machine for finishing work pieces ready to use with rotation symmetrically and optionally non rotation symmetrical, concentric and also eccentric circumferential surfaces and adjacent side surfaces, having crank shafts, said turning machine comprising:
a machine bed,
a spindle stock, with clamping chuck,
an opposite spindle stock with clamping chuck,
a controlled C-axis,
at least one vertical support,
a milling unit with a disc cutter or with an orthogonal cutter, wherein the orthogonal cutter includes a Y-axis or a pivoting around the C-axis in addition to the X-axis, and
a finishing unit and/or a grinding disc rotating about the C-axis.

19. The turning machine according to claim 18, characterized in that
the turning machine includes a laser unit for impacting the circumferential surface of the work piece and/or
an activatable and de-activatable measuring device.
